(19) United States
(12) Patent Application Publication
(10) Pub. No.: US 2013/0070138 A1
(43) Pub. Date: Mar. 21, 2013

(54) Number Of Pixels In Detector Arrays Using Compressive Sensing

(71) Applicants: Richard G Baraniuk, Houston, TX (US); Kevin F. Kelly, Houston, TX (US); Gary Woods, Houston, TX (US)

(72) Inventors: Richard G Baraniuk, Houston, TX (US); Kevin F. Kelly, Houston, TX (US); Gary Woods, Houston, TX (US)

(21) Appl. No.: 13/580,443

(22) PCT Filed: Feb. 22, 2011
(86) PCT No.: PCT/US2011/025776

§ 371 Date: Dec. 5, 2012

Related U.S. Application Data
(60) Provisional application No. 61/306,824, filed on Feb. 22, 2010.

(51) Int. Cl. H04N 5/378

(52) U.S. Cl. CPC H04N 5/378
USPC 348/302

(57) ABSTRACT

A method and apparatus using the techniques of compressive sensing, which has so far been applied mostly to improving a single-pixel detector into an effectively N-pixel detector, for improving a P-pixel detector array into an effectively P×N-pixel detector array.

### CROSS-REFERENCE TO RELATED APPLICATIONS

The present application claims the benefit of the filing date of U.S. Provisional Patent Application Ser. No. 61/306,824 entitled “Improved Pixel Counts in Detector Arrays Using Compressive Sensing” and filed by the present inventors on Feb. 22, 2010.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

1. Field of the Invention

The invention relates to imaging devices such as cameras, video cameras, microscopes, and other visualization techniques, and more particularly, to methods and apparatus for improved number of pixels in detector arrays.

2. Brief Description Of The Related Art

A theory known as Compressive Sensing (CS) has emerged that offers both theory and practical strategies for directly acquiring a compressed digital representation of a signal without first sampling that signal. See Candès, E., Romberg, J., Tao, T., “Robust uncertainty principles: Exact signal reconstruction from highly incomplete frequency information,” IEEE Trans. Inform. Theory 52 (2006) 489-509; David Donoho, “Compressed Sensing,” IEEE Transactions on Information Theory, Volume 52, Issue 4, April 2006, Pages: 1289-1306; and Candès, E., Tao, T., “Near optimal signal recovery from random projections and universal encoding strategies,” (2004) Preprint. Various schemes for directly applying this new theory in image acquisition have been presented in patent applications and in the literature, but those systems and methods typically employ a single modulator scheme. For example, in U.S. Patent Application Publication No. 2006239336, entitled “Method and Apparatus for Compressive Imaging Device,” the inventors disclosed a system and method for a new digital image/video camera that directly acquires random projections without first collecting the N pixels/voxels. Due to this unique measurement approach, it had the ability to obtain an image with a single detection element while measuring the image far fewer times than the number of pixels/voxels. The image could be reconstructed, exactly or approximately, from these random projections by using a model, in essence to find the best or most likely image (in some metric) among all possible images that could have given rise to those same measurements. A small number of detectors, even a single detector, could be used. Thus, the camera could be adapted to image at wavelengths of electromagnetic radiation that were impossible with conventional CCD and CMOS imagers. This feature was deemed to be particularly advantageous, because in some cases the usage of many detectors is impossible or impractical, whereas the usage of a small number of detectors, or even a single detector, may become feasible using compressive sensing.

CS builds on the work of Candès, Romberg, and Tao (see E. Candès, J. Romberg, and T. Tao, “Robust uncertainty principles: Exact signal reconstruction from highly incomplete frequency information,” IEEE Trans. Inf. Theory, vol. 52, no. 2, pp. 489-509, 2006) and Donoho (see D. Donoho, “Compressed sensing,” IEEE Trans. Inf. Theory, vol. 52, no. 4, pp. 1289-1306, 2006), who showed that if a signal has a sparse representation in one basis then it can be recovered from a small number of projections onto a second basis that is incoherent with the first. Roughly speaking, incoherence means that no element of one basis has a sparse representation in terms of the other basis. This notion has a variety of formalizations in the CS literature (see E. Candès, J. Romberg, and T. Tao, “Robust uncertainty principles: Exact signal reconstruction from highly incomplete frequency information,” IEEE Trans. Inf. Theory, vol. 52, no. 2, pp. 489-509, 2006; D. Donoho, “Compressed sensing,” IEEE Trans. Inf. Theory, vol. 52, no. 4, pp. 1289-1306, 2006; E. Candàs and T. Tao, “Near optimal signal recovery from random projections and universal encoding strategies,” August 2004, Preprint and J. Tropp and A. C. Gilbert, “Signal recovery from partial information via orthogonal matching pursuit,” April 2005, Preprint).

In fact, for an N-sample signal that is K-sparse, only K+1 projections of the signal onto the incoherent basis are required to reconstruct the signal with high probability. By K-sparse, we mean that the signal can be written as a sum of K basis functions from some known basis. Unfortunately, this requires a combinatorial search, which is prohibitively complex. Candàs et al. (see E. Candàs, J. Romberg, and T. Tao, “Robust uncertainty principles: Exact signal reconstruction from highly incomplete frequency information,” IEEE Trans. Inf. Theory, vol. 52, no. 2, pp. 489-509, 2006) and Donoho (see D. Donoho, “Compressed sensing,” IEEE Trans. Inf. Theory, vol. 52, no. 4, pp. 1289-1306, 2006) have recently proposed tractable recovery procedures based on linear programming, demonstrating the remarkable property that such procedures provide the same result as the combinatorial search as long as cK projections are used to reconstruct the signal (typically c 3 or 4) (see E. Candès and T. Tao, “Error correction via linear programming,” Found. of Comp. Math., 2005, Submitted; D. Donoho and J. Tanner, “Neighborliness of randomly projected simplices in high dimensions,” March 2005, Preprint and D. Donoho, “High-dimensional centrally symmetric polytopes with neighborliness proportional to dimension,” January 2005, Preprint). Iterative greedy algorithms have also been proposed (see J. Tropp, A. C. Gilbert, and M. J. Strauss, “Simultaneous sparse approximation via greedy pursuit,” in IEEE 2005 Int. Conf. Acoustics, Speech, Signal Processing (ICASSP), Philadelphia, March 2005; M. F. Duarte, M. B. Wakin, and R. G. Baraniuk, “Fast reconstruction of piecewise smooth signals from random projections,” in Online Proc. Workshop on Signal Processing with Adaptative Sparse Structured Representations (SPARS), Rennes, France, November 2005 and C. La and

M. N. Do, “Signal reconstruction using sparse tree representation,” in Proc. Wavelets XI at SPIE Optics and Photonics, San Diego, August 2005), allowing even faster reconstruction at the expense of slightly more measurements.

In U.S. Pat. No. 7,271,747, entitled “Method and Apparatus for Distributed Compressed Sensing,” the inventors disclosed, among other embodiments, a method for approximating a plurality of digital signals or images using compressed sensing. In a scheme where a common component x_{c} of said plurality of digital signals or images an innovative component xᵢ of each of said plurality of digital signals each are represented as a vector with m entries, the method comprises the steps of making a measurement yₒ where y_{c} comprises a vector with only nᵢ entries, where nᵢ is less than m, making a measurement yᵢ for each of said correlated digital signals, where yᵢ comprises a vector with only nᵢ entries, where nᵢ is less than m, and from each said innovation components yᵢ, producing an approximate reconstruction of each m-vector xᵢ using said common component y_{c} and said innovative component yᵢ.

### SUMMARY OF THE INVENTION

The present invention solves the problem of limited resolution in infrared imaging of semiconductor devices, although it is applicable to any imaging situation in which an increased number of pixels or increased resolution is desired.

In a preferred embodiment, the present invention is an image detector. The image detector comprises a light focusing element such as a lens, a spatial light modulator with P×N resolution elements or pixels where P>1, N>1 and variable patterns are applied to the spatial light modulator, a re-imaging element such as a re-imaging lens, a P-pixel focal plane array detector, an analog-to-digital (A/D) converter connected to an output of the P-pixel focal plane array and a processor, wherein the processor recovers an image corresponding to an incident light field passing through the light focusing element using fewer than N times P measurements.

The spatial light modulator may comprise a shadow mask having a substantially N×P pattern of holes. The shadow mask may be mechanically moved across an intermediate image plane in two transverse dimensions to produce a random pattern. In another embodiment, the spatial light modulator comprises a digital micromirror device. The image detector may further comprise a means, such as a laser, for illuminating an object. The P-pixel focal plane array detector may comprise a plurality of individually addressable photodiodes.

In yet another embodiment, the spatial light modulator comprises a plurality of shadow masks in series, wherein each of the plurality of shadow masks comprises a random pattern. The plurality of shadow masks maybe moved independently of one another. One or all of said shadow masks may comprise a plurality of spectrally-selective pixels and a plurality of spatially selective pixels.

In another preferred embodiment, the present invention is an image detector. The image detector comprises means for focusing light received at the image detector, a P×N spatial light modulator for modulating light received from said means for focusing light, wherein P>1, N>1 and variable patterns are applied to said spatial light modulator, a re-imaging element, a P-pixel focal plane array detector, and means for recovering an image from outputs of said focal plane array detector using fewer than N times P measurements. The means for recovering may comprise, for example, an A/D converter connected to an output of said P-pixel focal plane array detector and means, such as a processor, for performing a recovery algorithm.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a diagram of a preferred embodiment of the present invention.

### DETAILED DESCRIPTION OF THE PREFERRED EMBODIMENTS

After fabrication, a large fraction of integrated circuits fail for various reasons. A key technique for finding the root cause of the failures is to analyze infrared images of the devices. Such devices contain hundreds of millions of transistors, each of which could emit light that points to the root cause. However, detector arrays currently available and those available in the foreseeable future have less than 1 Mpixel. Thus, one is forced to take multiple images of an integrated circuit (IC) at high magnification (and lower field of view) in order to precisely locate defect spots. The inventive technique disclosed here boosts the effective pixel count of the detector array by a factor of easily 10 and conceivably up to 10⁴ or more. This would allow one to accomplish single-FOV imaging of an entire die in the semiconductor application space. Any image in which a pixel count significantly higher than the number of elements available in an array is required could benefit from this technique.

Using the techniques of compressive sensing, which have so far been applied mostly to boosting a single-pixel detector into an effectively N-pixel detector, the present invention boosts a P-pixel detector into an N×P-pixel detector. The idea is to form an intermediate image of the scene at an intermediate image plane. In this plane is situated a spatial light modulator (SLM) with at least N×P pixel elements. For convenience this could be a shadow mask with a pseudo-random pattern of holes. Another option would be a device such as a digital micromirror device (DMD). A DMD may comprise, for example, an array of electrostatically actuated micromirrors where each mirror of the array is suspended above an individual SRAM cell. Each mirror rotates about a hinge and can be positioned in one of two states (for example, +12 degrees and −12 degrees from horizontal); thus light falling on the DMD may be reflected in two directions depending on the orientation of the mirrors.

The SLM is then imaged onto the detector array, which is composed of P pixels. Thus there are N sub-pixels in the SLM imaged onto each pixel of the detector array. In general half of the N pixels will be blocked by a series of pseudo-random patterns in the SLM, and for each pattern the light intensity falling on each pixel will be recorded.

A comparison of the present invention to a single-pixel camera is as follows. In the single-pixel camera case, one obtains an N-pixel image using a single detector and an N-element spatial light modulator. In this case, one obtains an N×P pixel image using P detectors (the pixel array) and an N×P spatial light modulator. In a single-pixel camera one only requires M measurements where M is typically a few percent of N as described above regarding compressive sensing. In the single-pixel camera case we envision N could be on the order of 1e6, and M/N can be on the order of 1-10%. In the present invention we assume M/N will be more like 20-50%, as the value of N will be smaller (perhaps 10-100 in a practical case). Still, the compressive sensing allows a significant improvement in resolution with a sub-linear increase in acquisition time.

Similar techniques have been proposed, for instance using pseudo-random phase shift masks in the pupil plane. See Ashok, A. and Neifeld, M. A., “Pseudo-random phase masks for superresolution imaging from subpixel shifting,” Appl. Opt., 46, pp. 2256-2268, 2007. Differences between that reference and the present invention are the following: (1) the mask is in the pupil rather than in an image plane; and (2) the mask is not time-variant but rather fixed. Another type of resolution-enhancement technique is to shift the image by sub-pixel amounts and re-sample multiple times. This is often called sub-stepping. See, for instance, Poletto, L. and Nocolosi, P., “Enhancing the spatial resolution of a two-dimensional discrete array detector,” Opt. Eng 38 (10), 1748 (October 1999). Sub-stepping is a useful technique but to improve the resolution by a factor of N, requires N sub-stepping measurements to be made. The present invention obtains a factor of N improvement in resolution while requiring fewer than N×P measurements from a P-pixel array due to the results of compressive sensing. An additional difference is that sub-stepping typically does not require an intermediate image plane, whereas in the present invention we assume the SLM is placed in the intermediate image plane.

A general imaging system includes a lens for collecting light from a sample and refocusing it onto an image plane. In the present invention, we consider a focal plane array (FPA) detector composed of a large number, P, of pixels. Each pixel, typically an individually-addressed photodiode, returns a voltage level proportional to the amount of light hitting the pixel within its spectrally-sensitive range. In the case of near-IR and longer wavelength imaging, the FPA is often quite expensive due to the exotic materials required to get the spectral sensitivity required (such as InGaAs, InSb, or HgCdTe). FPAs are also often cooled with liquid nitrogen, adding to the expense and inconvenience of use. Unlike with silicon imaging cameras, where megapixel imagers are commonplace and quite cheap, there are few if any megapixel detectors available on the market in the IR ranges considered here. Development of these types of devices has been quite slow; the main original drivers were military night-vision applications and the Hubble Space Telescope. So IR FPAs are overly expensive, offer limited numbers of pixels, and do not have an aggressive roadmap for improvement.

Using techniques from the field of compressive sensing (CS) it is possible to boost the effective pixel count of an existing FPA. In a traditional CS-based “single-pixel camera,” such as is disclosed in U.S. Patent Application Publication No. 2006239336, one creates N-pixel images from a 1-pixel detector. The pixellation comes from an N-pixel spatial light modulator (SLM) in an intermediate image plane. One imposes a series of random on/off patterns to the N pixels; the light transmission for each such pattern is recorded by the single pixel detector. Advanced algorithms then allow one to extract the N-pixel image from the raw data.

In that single pixel camera, an incident light field corresponding to the desired image x passes through a lens and is then reflected off a digital micromirror device (DMD) array whose mirror orientations are modulated in the pseudorandom pattern sequence supplied by the random number generator or generators. Each different mirror pattern produces a voltage at the single photodiode detector that corresponds to one measurement y(m). The voltage level is then quantized by an analog-to-digital converter or converters. The bitstream produced is then communicated to a reconstruction algorithm, for example in a processor, which yields the output image.

In the present invention, a P-pixel focal plane array (FPA) and an SLM (spatial light modulator) with N×P pixels are used to create an effective N×P array. For example, P˜1e5-1e6 and N˜10-1000 may be used for some practical applications. There is no single SLM available that has much more than 1e6 individually addressable elements. However, for this application such control is not necessary. One can use for example a shadow mask with at least an N×P pattern printed on it, which can be done lithographically. One moves this shadow mask across the image plane mechanically in the two transverse dimensions. This is sufficient to give reasonable randomness in the transmitted patterns. An even more elegant solution is to use two or more shadow masks in series, each with a random pattern. The masks can be moved independently to give the required pseudo-random patterns. This requires smaller ranges of motion for each mask. Each has about 70% average transmission (sqrt(2)) so that the overall transmission is the optimal 50% for CS.

An alternative variation is to employ some spectrally-selective pixels in one or both of the masks in order to provide some spectral information in addition to spatial information. Of particular interest in the failure analysis world would be short vs. long-pass filters to distinguish between hot-carrier light emission (which has a long—wavelength spectral peak typically between 1.3 and 1.5 um) from electron-hole recombination (which has a short-wavelength spectral peak near 1.1 um wavelength).

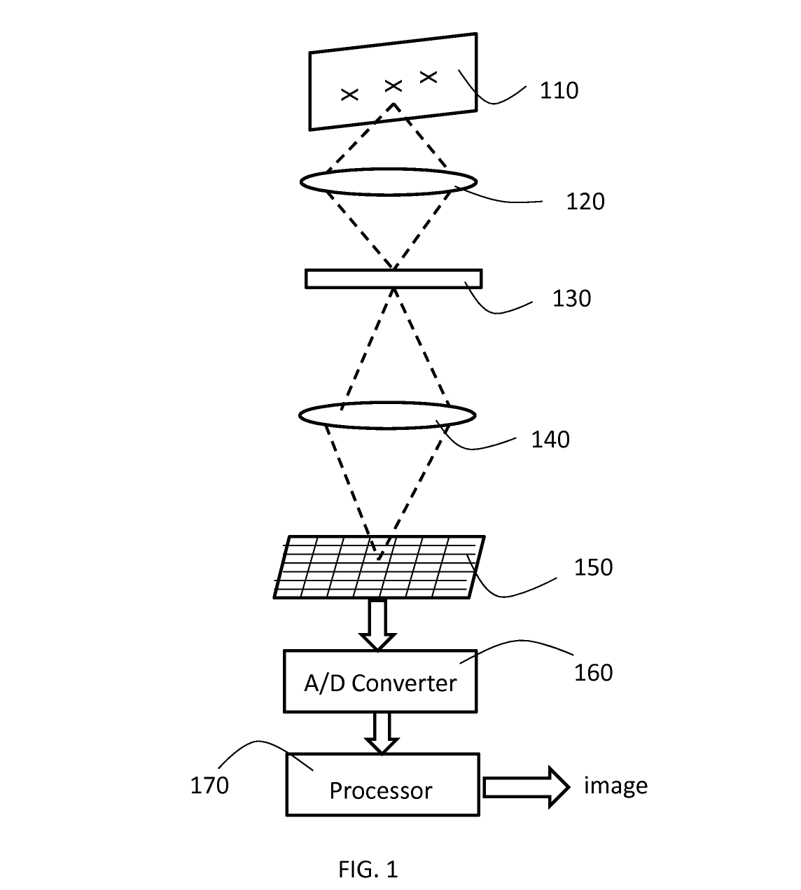

A setup of a preferred embodiment of the present invention, as shown in FIG. 1, has an object or scene 110, a lens or light collector 120, an N×P spatial light modulator, or SLM, 130, a re-imaging lens 140, and a P-pixel array detector 150. The object or scene 110 may be illuminated or may be self-luminous. An incident light field corresponding to the object or scene 110 passes through the lens or light collecting or focusing element 120. The light field is then reflected off SLM 130, which in a preferred embodiment is a DMD array whose mirror orientations are modulated in a pseudorandom pattern sequence supplied by a random number generator or generators. The spatial light modulator 130 having N×P pixels determines the pixel count. Further, the spatial light modulator in the intermediate image plane could include spectrally selective elements to provide spectral information in addition to spatial information. The modulated light then passes through a re-imaging element or lens 140 and onto the P-pixel array detector 150. The voltage levels from the P-pixel array detector 150 may then be quantized by an analog-to-digital converter(s) 160. The bitstream produced is then communicated to a reconstruction algorithm, for example in a processor 170, which yields an output or recovered image from substantially fewer than N×P measurements.

The steps in a method according to a preferred embodiment of the present invention may be as follows: (1) collecting light emitted or reflected/scattered from an object or image; (2) imaging the object onto a spatial light modulator (such as a digital micromirror device (DMD)); (3) applying a series of pseudo-random modulation patterns to the SLM according to standard compressive-sensing theory; (4) collecting the modulated light onto a P-pixel array detector; (5) recording or storing in a memory or storage the outputs of the P-pixel array detector; and (6) recovering the object or image by the algorithms of compressive sensing (CS) from fewer than N×P measurements.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. An image detector comprising:
a light focusing element;
a spatial light modulator with P×N resolution elements, wherein P>1, N>1 and variable patterns are applied to said spatial light modulator;
a re-imaging element;
a P-pixel focal plane array detector;
an A/D converter connected to an output of said P-pixel focal plane array; and
a processor;
wherein said processor recovers an image corresponding to an incident light field passing through said light focusing element using fewer than N times P measurements.

2. An image detector according to claim 1 wherein said spatial light modulator comprises a shadow mask having a substantially N×P pattern of holes, wherein said shadow mask is mechanically moved across an intermediate image plane in two transverse dimensions to produce a random pattern.

3. An image detector according to claim 1 wherein said spatial light modulator comprises a digital micromirror device.

4. An image detector according to claim 1 wherein said light focusing element comprises a lens.

5. An image detector according to claim 1 wherein said re-imaging element comprises a re-imaging lens.

6. An image detector according to claim 1, further comprising a plurality of shadow masks in series, wherein each of said plurality of shadow masks comprises a pseudo-random pattern.

7. An image detector according to claim 6, wherein said plurality of shadow masks are moved independently of one another.

8. An image detector according to claim 6, wherein one of said shadow masks comprises a plurality of spectrally-selective pixels and a plurality of spatially selective pixels.

9. An image detector according to claim 6, wherein each of said shadow masks comprises a plurality of spectrally-selective pixels and a plurality of spatially selective pixels.

10. An image detector according to claim 1, further comprising a means for illuminating an object.

11. An image detector according to claim 1 wherein said P-pixel focal plane array detector comprises a plurality of individually addressable photodiodes.

12. An image detector comprising:
means for focusing light received at said image detector;
a P×N spatial light modulator for modulating light received from said means for focusing light, wherein P>1, N>1 and variable patterns are applied to said spatial light modulator;
a re-imaging element;
a P-pixel focal plane array detector; and
means for recovering an image from outputs of said focal plane array detector using fewer than N×P measurements.

13. An image detector according to claim 12, wherein said means for recovering comprises:
an A/D converter connected to an output of said P-pixel focal plane array detector; and means for performing a recovery algorithm.
